(19) United States
(12) Patent Application Publication
(10) Pub. No.: US 2021/0239870 A1
(43) Pub. Date: Aug. 5, 2021

(54) WAVE-FIELD SIMULATION METHOD FOR EXTENDING FINITE-DIFFERENCE STABILITY CONDITIONS, AND APPARATUS AND MEDIUM FOR IMPLEMENTING SAME

(71) Applicant: INSTITUTE OF GEOLOGY AND GEOPHYSICS,CHINESE ACADEMY SCIENCES, BEIJING (CN)

(72) Inventors: YINGJIE GAO, BEIJING (CN); JINHAI ZHANG, BEIJING (CN); ZHENXING YAO, BEIJING (CN)

(21) Appl. No.: 16/973,230

(22) PCT Filed: Jun. 6, 2019
(86) PCT No.: PCT/CN2019/090303

§ 371 Date: Dec. 8, 2020

(30) Foreign Application Priority Data
Jun. 8, 2018 (CN) 201810585618.7

(51) Int. Cl. G01V 1/32; G01V 1/28

(52) U.S. Cl. CPC G01V 1/32; G01V 1/282

(57) ABSTRACT

A wavefield simulation method for extending the explicit finite-difference stability condition comprises: performing a time-step iteration on the basis of a wave-field numerical simulation model and adopting the spatial filtering method to filter out wave-field components appearing in the high wave number region (S1); when all time-step iterations end, saving wave-field data that obtained from the time iterations (S2); performing the inverse time-dispersion transform on the target wave-field data required to be output from the wave-field data, so as to obtain the wave-field data with time-dispersion removed (S3); and saving the wave-field data after the inverse time-dispersion transform processing (S4). Further provided are an electronic apparatus and a computer-readable storage medium used to implement the wave-field simulation method for extending the explicit finite-difference stability conditions.

### TECHNICAL FIELD

The application relates to the field of wave-field simulation, in particular to a wave-field simulation method for extending finite-difference stability conditions, an apparatus and a medium.

### BACKGROUND

Explicit finite difference method is a time partial derivative resolving method that is most widely used in the current wave-field simulation field because it is simple in form and easy to realize. Wherein, simulation accuracy and calculation efficiency are two most important factors of explicit finite-difference analysis, and the time step selected for numerical simulation would affect both on the accuracy and the efficiency of the numerical simulation.

If the time step is small enough, high-accuracy numerical simulation results can be obtained even during long-term numerical simulation without causing time-dispersion, but a small time step would increase the calculation amount and reduce the calculation efficiency. On the contrary, the maximum time step of the explicit finite difference is restricted by the Courant-Friedrichs-Lewy (CFL) stability condition, so when a large time step close to the upper limit of the CFL stability condition is adopted, the calculation efficiency is high, but the calculation accuracy is low, and severe time-dispersion still exists even in short-time simulation results. Because it is necessary to use a small time step in velocity models of refined structures and high-velocity regions, the number of iterations of numerical simulation is increased, and the calculation efficiency is reduced.

It has been proved that time-dispersion is independent of spatial dispersion, and many methods for removing time-dispersion have been put forward, which makes it possible to use a larger time step (close to the upper limit of the stability condition) for numerical simulation without causing time dispersion. Although the problem of time dispersion caused by a large time step has been solved, the time step used for explicit finite difference in the wave-field simulation field is still restricted by the stability condition and cannot be too large.

Implicit finite difference is unconditionally stable, so any time step can be used without being restricted by the CFL stability condition, regardless of the calculation accuracy. However, a large matrix needs resolved for the implicit finite difference method, so compared with the explicit finite difference, the calculation amount is larger, and the calculation efficiency is lower.

A method for realizing unconditional stability of the explicit finite difference by means of spatial filtering has been adopted in the electromagnetic wave simulation field, and it is the first time that a numerical simulation method for extending the stability condition of the explicit finite difference method is provided.

However, the numerical simulation method for extending the stability condition of the explicit finite difference method by means of spatial filtering in the electromagnetic wave simulation field has not yet been applied to the seismic wave simulation field. Moreover, the filtering method for electromagnetic waves fails to solve the problem of time-dispersion that caused by a large time step. Since a large time step used for wave-field simulation will cause severe time-dispersion, it is far from satisfactory to extend the stability condition only, and the problem of time-dispersion should also be solved.

### SUMMARY

To solve the problem that the time step is restricted by the CFL stability condition and the problem that time-dispersion will be caused when a large time step is used for wavefield simulation, the application provides a wavefield simulation method for extending the finite-difference stability conditions, an apparatus and a medium. The spatial filtering method is used to filter out the wavefields greater than a threshold Kₘₐₓ in the wave number domain so as to extend explicit finite-difference stability conditions in the wave-field simulation field; in addition, The inverse time-dispersion transformation is adopted to remove time dispersion caused by a large time step during simulation, so that a large time step can be used for numerical simulation after the stability conditions are extended. The invention aims to develop a novel method and tool for realizing high-accuracy and high-efficiency wave-field numerical simulation.

The application provides a wave-field simulation method for extending the explicit finite-difference stability conditions, comprising: performing a time-step iteration on the basis of a wave-field numerical simulation model and adopting a spatial filtering method to filter out unstable wave-field components distributed in the high wave number region; when all time-step iterations end, saving wave-field data obtained from the time iterations; performing the inverse time-dispersion transform on target wave-field data required to be output from the wave-field data, so as to obtain wave-field data with time dispersion removed; and storing the wave-field data obtained after the inverse time-dispersion transform processing.

Furthermore, before performing a time-step iteration on the basis of a wave-field numerical simulation model and adopting a spatial filtering method to filter out unstable wave-field components distributed in the high wave number region, the method further comprises: performing the forward time-dispersion transform on the first source time function on the basis of a given time step and a given time discretization scheme, so as to obtain the second source time function, wherein the second source time function replaces the first source time function to serve as an input of the wave-field numerical simulation model to perform the time-step iteration.

Furthermore, performing a time-step iteration on the basis of a wave-field numerical simulation model and adopting a spatial filtering method to filter out unstable wave-field components distributed in the high wave number region comprises the following steps: performing the time-step iteration on the basis of the wave-field numerical simulation model to figure out a maximum wave number threshold corresponding to the given time step and meeting a CFL stability condition; when the time-step iteration ends, transforming a spatial domain to a wave number domain; filtering out wave-field components greater than the maximum wave number threshold by a low-pass filter; after filtering, transforming the wave number domain back to the spatial domain; and performing a next time-step iteration.

Furthermore, parameters of the wave-field numerical simulation model include the spatial grid size, the maximum velocity of the model, the time step, and the discretization scheme of temporal and spatial variables.

Furthermore, the CFL stability condition corresponding to the maximum wave number threshold is a critical state of the CFL stability condition.

Furthermore, the spatial domain is transformed to the wave number domain by means of Fourier transform, and the wave number domain is transformed to the spatial domain by means of inverse Fourier transform.

Furthermore, an expression of the low-pass filter is:

$$F ( k ) = \{ \begin{matrix}1 , & k \leq K max \\ 0 , & Others ,\end{matrix}$$

Wherein, F(k) is the low-pass filter, k is the wave number, and the upper limit of the low-pass filter is the maximum wave number threshold Kmax.

Furthermore, the inverse time-dispersion transform comprises the following steps: calculating an actual phase shift θ(ω, Δt) regarding an effective frequency according to a dispersion relation obtained after time discretization, wherein ω is the frequency, and Δt is the time step; applying a transformation: û′(ω)=∫u(t)e^{-i[θ(ω, Δt)/Δt]t}dt, wherein u (t) is the target wave-field data required to be output; and performing inverse Fourier transform:

$${u}^{′} ( t ) = \frac{1}{2 π} \int {\hat{u}}^{′} ( ω ) {e}^{i \text{?}} d ω$$

$$\text{?} \text{indicates text missing or illegible when filed}$$

to obtain the wave-field data u′(t) with time dispersion removed.

The application further provides a wave-field simulation device for extending finite-difference stability conditions, comprising a filtering unit, an intermediate wave-field data storage unit, the inverse time-dispersion transform unit and a result wave-field data storage unit, wherein the filtering unit is used for performing a time-step iteration on the basis of a wave-field numerical simulation model and adopting a spatial filtering method to filter out unstable wave-field components distributed in the high wave number region; the intermediate wave-field data storage unit is used for saving wave-field data obtained from time iterations when all the time-step iterations end; the inverse time-dispersion transform unit is used for performing the inverse time-dispersion transform on target wave-field data required to be output from the wave-field data, so as to obtain wave-field data with time-dispersion error removed; and the result wave-field data storage unit is used for storing the wave-field data obtained after the inverse time-dispersion transform processing.

Furthermore, the device further comprises the forward time-dispersion transform unit which is used for performing the forward time-dispersion transform on the first source time function on the basis of a given time step and a given time discretization scheme, so as to obtain the second source time function, wherein the second source time function replaces the first source time function to serve as an input of the wave-field numerical simulation model to perform the time-step iteration.

Furthermore, the filtering unit comprises a time-step iteration unit, a spatial domain transformation unit, a low-pass filter and a wave-number domain transformation unit, wherein the time-step iteration unit is used for performing the time-step iteration on the basis of the wave-field numerical simulation model and the second source time function to figure out a maximum wave number threshold corresponding to the given step time and meeting a CFL stability condition; the spatial domain transformation unit is used for transforming a spatial domain to a wave number domain when the time-step iteration ends; the low-pass filter is used for filtering out wave-field components greater than the maximum wave number threshold; and the wave number domain transformation unit is used for transforming the wave number domain back to the spatial domain after filtering so as to perform a next time-step iteration.

The application further provides an electronic apparatus, comprising a memory, a processor, and a computer program which is stored in the memory and is to be run in the processor, wherein the processor executes the program to implement the wave-field simulation method for extending the explicit finite-difference stability conditions.

The application further provides a computer-readable storage medium having a processor program stored therein, wherein the processor program is used to implement the wave-field simulation method for extending the explicit finite-difference stability conditions.

According to the technical solution provided by the application, when a large time step is used for wave-field numerical simulation, the spatial filtering method is used to filter out unstable wave-field components in the high wave number region, so that the wave-field simulation can still be stable even if a large time step beyond the CFL stability condition is adopted; the inverse time-dispersion transform is adopted to remove time dispersion generated by a large time step to ensure that the precision of a final simulation result is almost consistent with that of a simulation result obtained with a small time step, so that the efficiency and precision of numerical simulation are guaranteed.

### BRIEF DESCRIPTION OF THE DRAWINGS

FIG. 1 is a flow diagram of a method provided by one embodiment of the application;

FIG. 2 is a flow diagram of a method provided by another embodiment of the application;

FIG. 3 is a flow diagram of a filtering method for the high wave number region provided by one embodiment of the application;

FIG. 4 is a component diagram of a device provided by one embodiment of the application;

FIG. 5 is a component diagram of a device provided by another embodiment of the application;

FIG. 6 is a component diagram of a filtering unit provided by one embodiment of the application;

FIG. 7 shows a wave field snapshot obtained under 333 ms when the time step Δt=3 ms is adopted in one embodiment of the application;

FIG. 8 shows single-trace waveform records obtained by simulation with different time steps in one embodiment of the application;

FIG. 9 shows single-trace waveform records obtained by simulation with different time steps in another embodiment of the application.

### DETAILED DESCRIPTION OF EMBODIMENTS

To clarify the purposes, technical solutions and advantages of the embodiments of the application, a more detailed and clearer description of the specific implementations of the technical solutions of the application will be given below in conjunction with the accompanying drawings and embodiments. Obviously, the specific implementations and embodiments described below are merely for the purpose of explanation, and are not intended to limit the application. The embodiments in the following description are only illustrative ones, and are not all possible ones of the application. All other embodiments obtained by those skilled in the art based on different variations to the application should also fall within the protection scope of the application.

FIG. 4 is a component diagram of a device provided by one embodiment of the application. As shown, the device comprises a filtering unit 1, an intermediate wave-field data storage unit 2, The inverse time-dispersion transform unit 3 and a result wave-field data storage unit 4.

The filtering unit 1 is used for performing a time-step iteration on the basis of a wave-field numerical simulation model and adopting a spatial filtering method to filter out unstable wave-field components distributed in the high wave number region; the intermediate wave-field data storage unit 2 is used for saving wave-field data obtained from time iterations when all the time-step iterations end; the inverse time-dispersion transform unit 3 is used for performing the inverse time-dispersion transform on target wave-field data required to be output from the wave-field data, so as to obtain wave-field data with time-dispersion removed; and the result wave-field data storage unit 4 is used for storing the wave-field data obtained after the inverse time-dispersion transform processing.

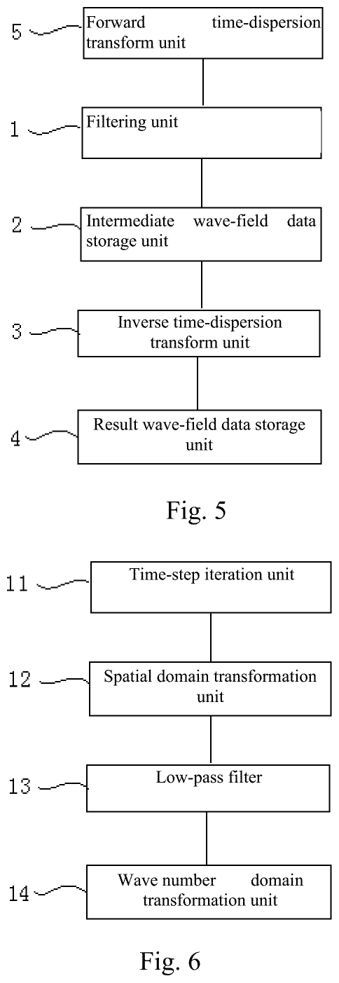

FIG. 5 is a component diagram of a device provided by another embodiment of the application. As shown, the device comprises the forward time-dispersion transform unit 5, a filtering device 1, an intermediate wave-field data storage unit 2, the inverse time-dispersion transform unit 3 and a result wave-field data storage unit 4.

The forward time-dispersion transform unit 5 is used for performing a forward time-dispersion transform on the first source time function on the basis of a given time step and a given time discretization scheme, so as to obtain the second source time function, wherein the second source time function replaces the first source time function to serve as an input of the wave-field numerical simulation model to perform a time-step iteration. The filter unit 1 is used for performing the time-step iteration on the basis of a wave-field numerical simulation model and adopting a spatial filtering method to filter out unstable wave-field components distributed in the high wave number region. The intermediate wave-field data storage unit 2 is used for saving wave-field data obtained from time iterations when all the time-step iterations end. The inverse time-dispersion transform unit 3 is used for performing the inverse time-dispersion transform on target wave-field data required to be output from the wave-field data, so as to obtain wave-field data with time-dispersion removed. The result wave-field data storage unit 4 is used for storing the wave-field data obtained after the inverse time-dispersion transform processing.

FIG. 6 is a component diagram of a filtering unit provided by one embodiment of the application. As shown, the filtering unit comprises a time-step iteration unit 11, a spatial domain transformation unit 12, a low-pass filter 13 and a wave-number domain transformation unit 14.

The time-step iteration unit 11 is used for performing the time-step iteration on the basis of the wave-field numerical simulation model to figure out a maximum wave number threshold corresponding to the given step time and meeting a CFL stability condition; the spatial domain transformation unit 12 is used for transforming a spatial domain to a wave number domain when the time-step iteration ends; the low-pass filter 13 is used for filtering out wave-field components greater than the maximum wave number threshold; and the wave number domain transformation unit 14 is used for transforming the wave number domain back to the spatial domain after filtering so as to perform a next time-step iteration.

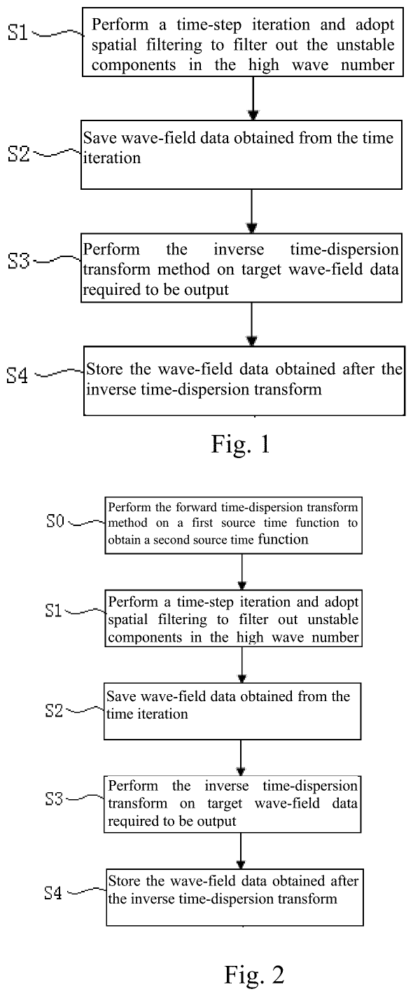

FIG. 1 is a flow diagram of a method provided by one embodiment of the invention. As shown, the method comprises the following steps:

S1: a time-step iteration is performed on the basis of a wave-field numerical simulation model, and a spatial filtering method is adopted to filter out unstable wave-field components distributed in the high wave number region;

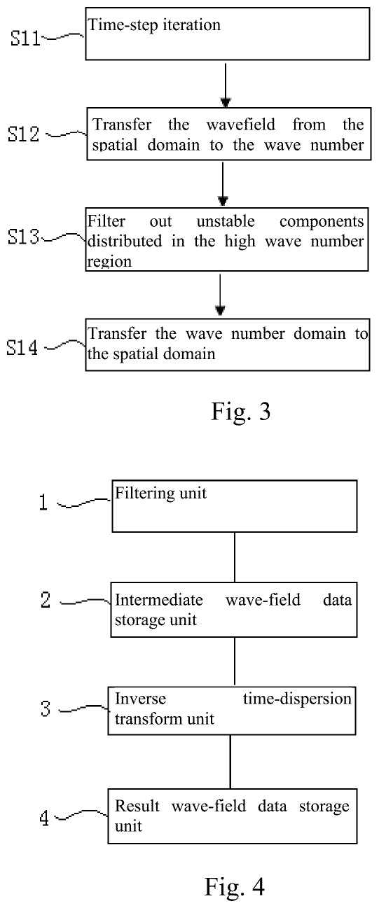

As shown in FIG. 3 which is a flow diagram of a filtering method for the high wave number region of the application, the filtering method comprises the following steps:

S11: the time-step iteration is performed on the basis of the wave-field numerical simulation model to figure out a maximum wave number threshold corresponding to a given time step and meeting a CFL stability condition.

Parameters of the wave-field numerical simulation model include a spatial grid size, a maximum speed of the model, a time step, and a discretization scheme of time and spatial variables.

The CFL stability condition corresponding to the maximum wave number threshold Kmax is a critical state of the CFL stability condition.

The CFL condition is named after Courant, Friedrichs and Lewy who put forward this concept in an article about a finite difference method for partial differential equations in 1928 for the purpose of proving the existence of solutions to some partial differential equations by means of the finite difference method rather than for analyzing the stability of difference schemes. The basic idea is that a difference equation is established to obtain a sequence approximate to a solution, so that as long as the approximated sequence converges in a given grid system, it can be easily proved that the convergent solution is the solution of the original differential equation.

A condition for converging the approximated sequence is the well-known CFL condition, which is defined as follows: an essential condition of a numerical method realizes the convergence of the difference scheme of a PDE only in its numerical domain of dependence is that the domain of dependence of the difference scheme includes the domain of dependence of the PDE.

With the rapid development of computers, the finite difference method and the finite volume method are being applied to numerical simulation of hydromechanics more and more widely, and the CFL condition, as a criterion of scheme stability and convergence, is becoming ever important. It's worth noting that the CFL condition is an essential condition rather than a sufficient condition of the stability (convergence).

S12: when the time-step iteration ends, a spatial domain is transformed to a wave number domain.

S13: wave-field components greater than the maximum wave number threshold are filtered out by a low-pass filter.

The upper limit of the low-pass filter is Kmax.

An expression of the low-pass filter is:

$$F ( k ) = \{ \begin{matrix}1 , & k \leq K max \\ 0 , & Others ,\end{matrix}$$

Wherein, F(k) is the low-pass filter, k is the wave number, and the upper limit of the low-pass filter is Kmax.

Experiments have shown that when the time step meeting the CFL stability condition is used for numerical simulation, unstable components are mainly from the high wave number region exceeding the corresponding wave number threshold. As long as by transforming wave fields in space to the wave number domain by means of fast Fourier transform at the end of each time-step iteration, filtering out wave fields greater than the corresponding threshold and then transforming the wave field domain to the spatial domain by means of Fourier transform, the unstable wave-field components caused by a large time step will be filtered rather than being accumulated, and instabilities of numerical simulation will be avoided. Meanwhile, effective wave-field components are mainly distributed in a low wave number region and will not be filtered out, so that an effective wave field will not be affected by spatial filtering.

S14: after filtering, the wave number domain is transformed back to the spatial domain by means of inverse Fourier transform.

S2: when all time-step iterations end, wave-field data obtained from the time iterations is saved.

S3: the inverse time-dispersion transform is performed on target wave-field data required to be output from the wave-field data, so as to obtain wave-field data with time-dispersion removed.

A large time step will cause time dispersion, which reduces the precision of numerical simulation. Inverse-time dispersion is a post-processing technique, and the inverse time-dispersion transform can effectively remove time dispersion and improve the simulation precision.

The inverse time-dispersion transform comprises the following steps:

An actual phase shift θ(ω, Δt) regarding an effective frequency is calculated according to a dispersion relation obtained after time discretization, wherein ω is the frequency, and Δt is the time step;

A transformation: û′(ω)=∫u(t)e^{-i[θ(ω, Δt)/Δt]t}dt is applied, wherein u (t) is the target wave-field data required to be output; and

Inverse Fourier transform:

$${u}^{′} ( t ) = \frac{1}{2 π} \int {{u}^{\text{?}}}^{′} ( ω ) {e}^{i \text{?}} d ω$$

$$\text{?} \text{indicates text missing or illegible when filed}$$

is performed to obtain the wave-field data u′(t) with time dispersion removed.

S4: the wave-field data obtained after the inverse time-dispersion transform processing is stored.

According to the technical solution provided by the application, when a large time step is used for wave-field numerical simulation, the spatial filtering method is used to filter out unstable wave-field components in the high wave number region, so that the wave-field simulation can still be stable even if a large time step beyond the CFL stability condition is adopted; the inverse time-dispersion transform is adopted to remove time dispersion generated by a large time step to ensure that the precision of a final simulation result is almost consistent with that of a simulation result obtained with a small time step, so that the efficiency and precision of numerical simulation are guaranteed.

FIG. 2 is a flow diagram of a method provided by another embodiment of the invention. As shown, the method comprises the following steps:

S0: The forward time-dispersion transform is performed on the first source time function on the basis of a given time step and a given time discretization scheme, so as to obtain the second source time function, wherein the second source time function replaces the first source time function to serve as an input of a wave-field numerical simulation model to perform a time-step iteration.

The forward time-dispersion transform may be regarded as modified Fourier transform.

A specific transformation formula is: Ŝ′(ω)=∫S(t)e^{-i[θ̅(ω, Δt)/Δt]t}dt.

Wherein, S(t) is the first source time function, and Ŝ′(ω) is the quantity of the first source time function in a frequency domain. θ̅(ω, Δt) is a theoretical phase shift regarding the effective frequency calculated by means of time dispersion, wherein ω is the frequency, and Δt is the time step.

Inverse Fourier transform is performed to obtain a new second source time function, wherein a specific transformation formula is:

$${S}^{′} ( t ) = \frac{1}{2 π} \int \hat{{S}^{′}} ( ω ) {e}^{i ωt} d ω .$$

S1: the time-step iteration is performed on the basis of a wave-field numerical simulation model, and a spatial filtering method is adopted to filter out unstable wave-field components distributed in the high wave number region;

S2: when all time-step iterations end, wave-field data obtained from the time iterations is saved.

S3: The inverse time-dispersion transform is performed on target wave-field data required to be output from the wave-field data, so as to obtain wave-field data with time-dispersion removed.

S4: the wave-field data obtained after the inverse time-dispersion transform processing is stored.

In this embodiment, the forward time-dispersion transform is performed on the source time function in advance, so that time dispersion in wave fields is removed more accurately by means of the inverse time-dispersion transform.

S1, S2, S3 and S4 in this embodiment are the same as those in the above embodiment and will not be detailed anymore.

An electronic apparatus comprises a memory, a processor, and a computer program which is stored in the memory and is to be run in the processor, wherein the processor executes the program to implement the wave-field simulation method for extending finite-difference stability conditions.

A computer-readable storage medium has a processor program stored therein, wherein the processor program is used to implement the wave-field simulation method for extending finite-difference stability conditions.

Wherein, the computer-readable storage medium may be, but is not limited to, a read-only memory (ROM), a random access memory (RAM), a CD read-only memory (CD-ROM), a magnetic tape, a floppy disk, an optical data storage device or the like, as the case may be.

### Embodiment 1

Specific application embodiments of the wave-field simulation method and device for extending explicit-difference stability conditions, the apparatus and the storage medium of the application are provided herein.

As shown in FIG. 4, the device comprises a filtering unit 1, an intermediate wave-field data storage unit 2, the inverse time-dispersion transform unit 3 and a result wave-field data storage unit 4.

The filtering unit 1 is used for performing a time-step iteration on the basis of a wave-field numerical simulation model and adopting a spatial filtering method to filter out unstable wave-field components distributed in the high wave number region; the intermediate wave-field data storage unit 2 is used for saving seismic traces obtained from time iterations when all the time-step iterations end; the inverse time-dispersion transform unit 3 is used for performing the inverse time-dispersion transform on a target seismic trace required to be output from wave-field data, so as to obtain the a seismic trace with time dispersion removed; and the result wave-field data storage unit 4 is used for storing the seismic trace obtained after the inverse time-dispersion transform processing.

The seismic traces are waveform records of wave-field values of spatial points with time, each time point corresponds to one seismic trace record which is referred to a single seismic trace, and the seismic traces form a time seismic wave field.

As shown in FIG. 6, the filtering unit 1 comprises a time-step iteration unit 11, a spatial domain transformation unit 12, a low-pass filter 13 and a wave-number domain transformation unit 14.

The time-step iteration unit 11 is used for performing the time-step iteration on the basis of the wave-field numerical simulation model to figure out a maximum wave number threshold corresponding to a given step time and meeting a CFL stability condition; the spatial domain transformation unit 12 is used for transforming a spatial domain to a wave number domain when the time-step iteration ends; the low-pass filter 13 is used for filtering out wave-field components greater than the maximum wave number threshold; and the wave number domain transformation unit 14 is used for transforming the wave number domain back to the spatial domain after filtering so as to perform a next time-step iteration.

As shown in FIG. 1 and FIG. 3, the method comprises the following steps:

S1: a time-step iteration is performed based on the wave-field numerical simulation model, and the spatial filtering method is adopted to filter out unstable wave-field components distributed in the high wave number region;

In this embodiment, the second source time function is used as an input of the wave-field numerical simulation model to perform the time-step iteration.

S11: the time-step iteration is performed based on the wave-field numerical simulation model to figure out a maximum wave number threshold Kmax corresponding to a given time step and meeting a CFL stability condition.

In a homogeneous medium, a two-dimensional acoustic equation is used for simulation, a pseudo-spectral method is used for spatial dispersion, and the second-order finite-difference scheme and the fourth-order finite-difference scheme are used for time dispersion. The spatial grid size is 10 m. The maximum time steps of a pseudo-spectral method (second-order finite difference) and a pseudo-spectral method (fourth-order finite difference) defined by the CFL stability condition are Δt=1.125 ms and Δt=1.949 ms, respectively. Herein, the time step Δt=3 ms is used for simulation, and wave-field instabilities happen to both schemes.

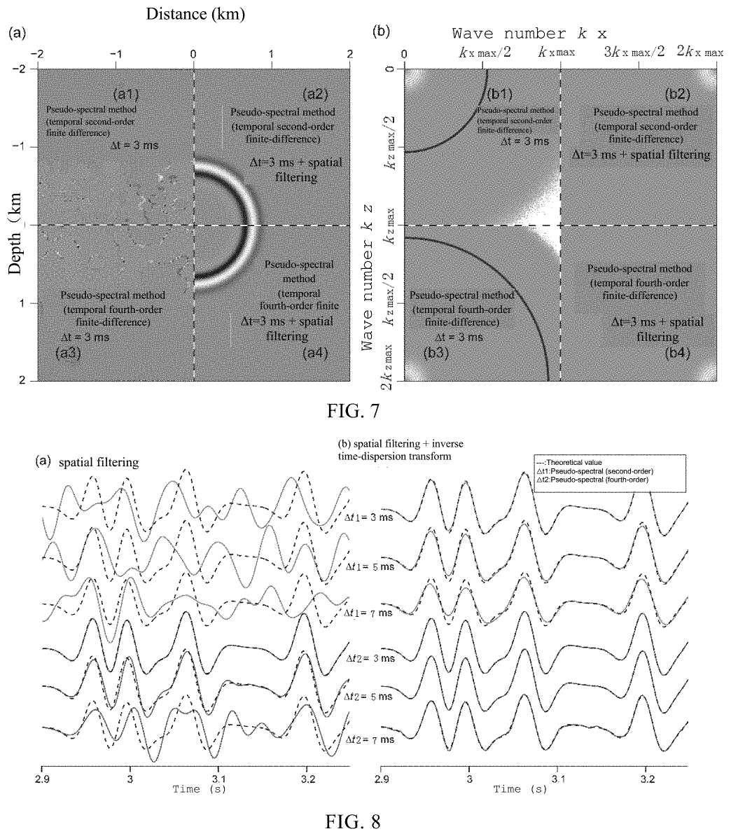

FIG. 7 shows a wave field snapshot obtained under 333 ms when the time step Δt=3 ms is adopted in one embodiment of the application.

In FIG. 7, a1 is a snapshot obtained through a pseudo-spectral method (temporal second-order finite difference) not adopting spatial filtering, and as can be seen, the wave field is unstable. In FIG. 7, b1 is a wave field obtained in the wave number domain after the wave field a1 in FIG. 7 is subjected to two-dimensional Fourier transform; as shown by b1 in FIG. 7, after wave-field components in the high wave number region are removed through a low-pass filter, b2 in FIG. 7 is obtained; the wave field of a spatial domain in a2 in FIG. 7 will be obtained by performing inverse Fourier transform on b2 in FIG. 7, so that original unstable components are filtered out. Similarly, as shown by a3 in FIG. 7, spatial filtering is also effective for unstable wave fields obtained through the pseudo-spectral method (temporal fourth-order finite difference). The snapshot obtained after filtering is shown by b4 in FIG. 7.

S12: when the time-step iteration ends, a spatial domain is transformed to a wave number domain by means of Fourier transform.

S13: wave-field components greater than the maximum wave number threshold Kmax are filtered out by a low-pass filter. An upper limit of the low-pass filter is Kmax.

An expression of the low-pass filter is:

$$F ( k ) = \{ \begin{matrix}1 , & k \leq K max \\ 0 , & Others ,\end{matrix}$$

Wherein, F(k) is the low-pass filter, k is the wave number, and the upper limit of the low-pass filter is Kmax.

S14: after filtering, the wave number domain is transformed back to the spatial domain by means of inverse Fourier transform.

S2: when all time-step iterations end, wave-field data obtained from the time iterations is saved.

S3: the inverse time-dispersion transform is performed on a target seismic trace required to be output from the wave-field data, so as to obtain a seismic trace with time dispersion removed.

A large time step will cause time dispersion, which reduces the precision of numerical simulation. Inverse-time dispersion is a post-processing technique, and the inverse time-dispersion transform can effectively remove time dispersion and improve simulation precision.

The inverse time-dispersion transform comprises the following steps:

An actual phase shift θ(ω, Δt) regarding an effective frequency is calculated according to a dispersion relation obtained after time discretization, wherein ω is the frequency, and Δt is the time step;

A transformation: û′(ω)=∫u(t)e^{-i[θ(ω, Δt)/Δt]t}dt is applied, wherein u(t) is the target seismic trace required to be output; and

Inverse Fourier transform:

$${u}^{′} ( t ) = \frac{1}{2 π} \int {{u}^{\text{?}}}^{′} ( ω ) {e}^{i \text{?}} d ω$$

$$\text{?} \text{indicates text missing or illegible when filed}$$

is performed to obtain the seismic trace u′(t) with time dispersion removed.

FIG. 8 shows single-trace waveform records obtained by fitting with different time steps in one embodiment of the application.

In FIG. 8, (a) shows single-trace waveform records obtained by simulation with different time steps after spatial filtering. Wherein, in (a) and (b), Δt1 in the three charts above is under the temporal second-order difference scheme of the pseudo-spectral method, and Δt2 in the three charts below is under the temporal fourth-order difference scheme of the pseudo-spectral method. As can be seen, in case of Δt1=Δt2=7 ms, instabilities still do not occur. The time dispersion becomes larger with the continuous increase of the time step, and the calculation precision decreases with the increase of the time step. (b) in FIG. 8 shows waveform records obtained after waveforms shown by (a) in FIG. 8 are subjected to the inverse time-dispersion transform. As can be seen, the time dispersion is effectively restrained. It can thus be seen from FIG. 8 that the precision of calculation results in case of Δt2=7 ms is still high particularly for the temporal fourth-order finite-difference scheme of the pseudo-spectral method.

S4: the seismic trace obtained after the inverse time-dispersion transform processing is stored.

In this embodiment, the CFL stability condition of explicit difference can be extended by means of spatial filtering, and the precision of numerical simulation can be ensured by means of the inverse time-dispersion transform when a large time step is adopted.

### Embodiment 2

Specific application embodiments of the wave-field simulation method and device for extending explicit-difference stability conditions, the apparatus and the storage medium of the application are provided herein.

As shown in FIG. 5, the device comprises the forward time-dispersion transform unit 5, a filtering unit 1, an intermediate wave-field data storage unit 2, the inverse time-dispersion transform unit 3 and a result wave-field data storage unit 4.

The forward time-dispersion transform unit 5 is used for performing the forward time-dispersion transform on the first source time function on the basis of a given time step and a given time discretization scheme, so as to obtain the second source time function, wherein the second source time function replaces the first source time function to serve as an input of a wave-field numerical simulation model to perform a time-step iteration. The filtering unit 1 is used for performing the time-step iteration on the basis of a wave-field numerical simulation model and adopting a spatial filtering method to filter out unstable wave-field components distributed in the high wave number region; the intermediate wave-field data storage unit 2 is used for saving seismic traces obtained from time iterations when all time-step iterations end; the inverse time-dispersion transform unit 3 is used for performing the inverse time-dispersion transform on a target seismic trace required to be output from the wave-field data, so as to obtain a seismic trace with time dispersion removed; and the result wave-field data storage unit 4 is used for storing the seismic trace obtained after the inverse time-dispersion transform processing.

The seismic traces are waveform records of wave-field values of spatial points with time, each time point corresponds to one seismic trace record which is referred to a single seismic trace, and the seismic traces form a time seismic wave field.

As shown in FIG. 6, the filtering unit 1 comprises a time-step iteration unit 11, a spatial domain transformation unit 12, a low-pass filter 13 and a wave-number domain transformation unit 14.

The time-step iteration unit 11 is used for performing the time-step iteration on the basis of the wave-field numerical simulation model to figure out a maximum wave number threshold corresponding to a given step time and meeting a CFL stability condition; the spatial domain transformation unit 12 is used for transforming a spatial domain to a wave number domain when the time-step iteration ends; the low-pass filter 13 is used for filtering out wave-field components greater than the maximum wave number threshold; and the wave number domain transformation unit 14 is used for transforming the wave number domain back to the spatial domain after filtering so as to perform a next time-step iteration.

As shown in FIG. 2 and FIG. 3, the method comprises the following steps:

S0: The forward time-dispersion transform is performed on the first source time function on the basis of a given time step and a given time discretization scheme, so as to obtain the second source time function, wherein the second source time function replaces the first source time function to serve as an input of the wave-field numerical simulation model to perform a time-step iteration.

The forward time-dispersion transform may be regarded as modified Fourier transform.

A specific transformation formula is: Ŝ′(ω)=∫S(t)e^{-i[θ̅(ω, Δt)/Δt]t}dt.

Wherein, S(t) is the first source time function, and Ŝ′(ω) is the quantity of the first source time function in a frequency domain. θ̅(ω, Δt) is a theoretical phase shift regarding an effective frequency calculated by means of time dispersion, wherein ω is the frequency, and Δt is the time step.

Inverse Fourier transform is performed to obtain a new second source time function, wherein a specific transformation formula is:

$${S}^{′} ( t ) = \frac{1}{2 π} \int \hat{{S}^{′}} ( ω ) {e}^{i ωt} d ω .$$

S1: a time-step iteration is performed on the basis of a wave-field numerical simulation model, and a spatial filtering method is adopted to filter out unstable wave-field components distributed in the high wave number region;

In this embodiment, the second source time function is used as an input of the wave-field numerical simulation model to perform the time-step iteration. Other steps except S1 are the same as those in Embodiment 1 and will not be detailed anymore.

S2: when all time-step iterations end, wave-field data obtained from the time iterations is saved.

S3: the inverse time-dispersion transform is performed on a target seismic trace required to be output from the wave-field data, so as to obtain a seismic trace with time dispersion removed.

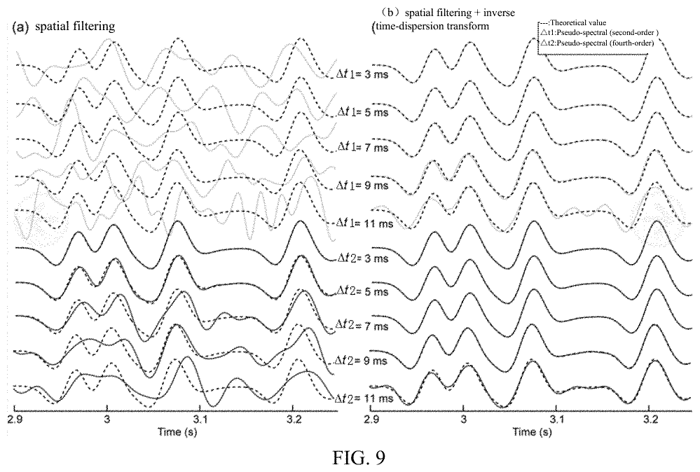

FIG. 9 shows single-trace waveform records obtained by simulation with different time steps in another embodiment of the application.

In FIG. 9, (a) shows single-trace waveform records obtained by simulation with different time steps after spatial filtering. Wherein, in (a) and (b), Δt1 in the five charts above is under the temporal second-order difference scheme of the pseudo-spectral method, and Δt2 in the five charts below is under the temporal fourth-order finite-difference scheme of the pseudo-spectral method. As can be seen, in case of Δt1=Δt2=7 ms, the stability is maintained, but instabilities occur when Δt1=Δt2=11 ms. The time dispersion becomes larger with the continuous increase of the time step, and the calculation precision decreases with the increase of the time step. (b) in FIG. 9 shows waveform records obtained after waveforms shown by (a) in FIG. 9 are subjected to an inverse time-dispersion transform. As can be seen, the time dispersion is effectively restrained. It can thus be seen from FIG. 9 that the precision of calculation results in case of Δt2=11 ms is still high particularly for the temporal fourth-order finite-difference scheme of the pseudo-spectral method.

S4: the seismic trace obtained after the inverse time-dispersion transform processing is stored.

S2, S3 and S4 in this embodiment are the same as those in the above embodiment, and thus will not be detailed anymore.

In this embodiment, the forward time-dispersion transform is performed on the source time function in advance, so that time dispersion in the wave field is removed more accurately by means of the inverse time-dispersion transform.

It should be noted that the embodiments described above with reference to the accompanying drawings are merely used for explaining the application, and are not intended to limit the scope of the application. All amendments or equivalent substitutions made by those ordinarily skilled in the art without departing from the sprit and scope of the application should also fall within the protection scope of the invention. In addition, unless otherwise specified in the specification, terms in the singular form may also be in the plural form, vice versa. Moreover, unless particularly stated, part or all of any embodiment can be combined with part or all of any other embodiments to be implemented.

What is claimed is:

1. A wave-field simulation method for extending the explicit finite-difference stability conditions, comprising:
performing a time-step iteration on the basis of a wave-field numerical simulation model and adopting a spatial filtering method to filter out unstable wave-field components distributed in the high wave number region;
when all time-step iterations end, saving wave-field data obtained from the time iterations;
performing the inverse time-dispersion transform on target wave-field data required to be output from the wave-field data, so as to obtain wave-field data with time-dispersion removed; and
storing the wave-field data obtained after the inverse time-dispersion transform processing.

2. The method according to claim 1, wherein before performing a time-step iteration on the basis of a wave-field numerical simulation model and adopting a spatial filtering method to filter out unstable wave-field components distributed in the high wave number region, the method further comprises:
performing the forward time-dispersion transform on the first source time function on the basis of a given time step and a given time discretization scheme, so as to obtain the second source time function, wherein:
the second source time function replaces the first source time function to serve as an input of the wave-field numerical simulation model to perform the time-step iteration.

3. The method according to claim 1, wherein performing a time-step iteration on the basis of a wave-field numerical simulation model and adopting a spatial filtering method to filter out unstable wave-field components distributed in the high wave number region comprises:
performing the time-step iteration on the basis of the wave-field numerical simulation model to figure out a maximum wave number threshold corresponding to the given time step and meeting a CFL stability condition;
when the time-step iteration ends, transforming a spatial domain to a wave number domain;
filtering out wave-field components greater than the maximum wave number threshold by a low-pass filter; and
after filtering, transforming the wave number domain back to the spatial domain, and performing a next time-step iteration.

4. The method according to claim 3, wherein parameters of the wave-field numerical simulation model include a spatial grid size, a maximum speed of the model, a time step, and a discretization scheme of time and spatial variables, and the CFL stability condition corresponding to the maximum wave number threshold is a critical state of the CFL stability condition.

5. The method according to claim 3, wherein the spatial domain is transformed to the wave number domain by means of Fourier transform, and the wave number domain is transformed to the spatial domain by means of inverse Fourier transform.

6. The method according to claim 3, wherein an expression of the low-pass filter is:
$$F ( k ) = \{ \begin{matrix}1 , & k \leq K max \\ 0 , & Others ,\end{matrix}$$
wherein, F(k) is the low-pass filter, k is a wave number, and an upper limit of the low-pass filter is the maximum wave number threshold Kmax.

7. The method according to claim 1, wherein the inverse time-dispersion transform comprises the following steps:
calculating an actual phase shift θ(ω, Δt) regarding an effective frequency according to a dispersion relation obtained after time discretization, wherein ω is a frequency, and Δt is a time step;
applying a transformation: û′(w)=∫u(t)e^{-i[θ(ω, Δt)/Δt]t}dt, wherein u (t) is the target wave-field data required to be output; and
performing inverse Fourier transform:
$${u}^{′} ( t ) = \frac{1}{2 π} \int {\hat{u}}^{′} ( ω ) {e}^{i ω t} d ω$$
to obtain the wave-field data u′(t) with time dispersion removed.

8. An electronic apparatus, comprising a memory, a processor, and a computer program which is stored in the memory and is to be run in the processor, wherein the processor implements a method comprising the following steps:
performing a time-step iteration on the basis of a wave-field numerical simulation model and adopting a spatial filtering method to filter out unstable wave-field components distributed in the high wave number region;
when all time-step iterations end, saving wave-field data obtained from the time iterations;
performing the inverse time-dispersion transform on target wave-field data required to be output from the wave-field data, so as to obtain wave-field data with time-dispersion removed; and
storing the wave-field data obtained after the inverse time-dispersion transform processing.

9. The apparatus according to claim 8, wherein before performing a time-step iteration on the basis of a wave-field numerical simulation model and adopting a spatial filtering method to filter out unstable wave-field components distributed in the high wave number region, the method further comprises:
performing the forward time-dispersion transform on the first source time function on the basis of a given time step and a given time discretization scheme, so as to obtain the second source time function, wherein:
the second source time function replaces the first source time function to serve as an input of the wave-field numerical simulation model to perform the time-step iteration.

10. The apparatus according to claim 8, wherein performing a time-step iteration on the basis of a wave-field numerical simulation model and adopting a spatial filtering method to filter out unstable wave-field components distributed in the high wave number region comprises:
performing the time-step iteration on the basis of the wave-field numerical simulation model to figure out a maximum wave number threshold corresponding to the given time step and meeting a CFL stability condition;
when the time-step iteration ends, transforming a spatial domain to a wave number domain;
filtering out wave-field components greater than the maximum wave number threshold by a low-pass filter; and
after filtering, transforming the wave number domain back to the spatial domain, and performing a next time-step iteration.

11. The apparatus according to claim 10, wherein parameters of the wave-field numerical simulation model include a spatial grid size, a maximum speed of the model, a time step, and a discretization scheme of time and spatial variables, and the CFL stability condition corresponding to the maximum wave number threshold is a critical state of the CFL stability condition.

12. The apparatus according to claim 10, wherein the spatial domain is transformed to the wave number domain by means of Fourier transform, and the wave number domain is transformed to the spatial domain by means of inverse Fourier transform.

13. The apparatus according to claim 10, wherein an expression of the low-pass filter is:
$$F ( k ) = \{ \begin{matrix}1 , & k \leq K max \\ 0 , & Others ,\end{matrix}$$
wherein, F(k) is the low-pass filter, k is a wave number, and an upper limit of the low-pass filter is the maximum wave number threshold Kmax.

14. The apparatus according to claim 8, wherein the inverse time-dispersion transform comprises the following steps:
calculating an actual phase shift θ(ω, Δt) regarding an effective frequency according to a dispersion relation obtained after time discretization, wherein ω is a frequency, and Δt is a time step;
applying a transformation: û′(ω)=∫u(t)e^{-i[θ(ω, Δt)/Δt]t}dt, wherein u(t) is the target wave-field data required to be output; and
performing inverse Fourier transform:
$${u}^{′} ( t ) = \frac{1}{2 π} \int {\hat{u}}^{′} ( ω ) {e}^{i ω t} d ω$$
to obtain the wave-field data u′(t) with time dispersion removed.

15. A computer-readable storage medium, having a processor program stored therein, wherein the processor program implements a method comprising the following steps:
performing a time-step iteration on the basis of a wave-field numerical simulation model and adopting a spatial filtering method to filter out unstable wave-field components distributed in the high wave number region;
when all time-step iterations end, saving wave-field data obtained from the time iterations;
performing the inverse time-dispersion transform on target wave-field data required to be output from the wave-field data, so as to obtain wave-field data with time-dispersion removed; and
storing the wave-field data obtained after the inverse time-dispersion transform processing.

16. The medium according to claim 15, wherein before performing a time-step iteration on the basis of a wave-field numerical simulation model and adopting a spatial filtering method to filter out unstable wave-field components distributed in the high wave number region, the method further comprises:
performing the forward time-dispersion transform on the first source time function on the basis of a given time step and a given time discretization scheme, so as to obtain the second source time function, wherein:
the second source time function replaces the first source time function to serve as an input of the wave-field numerical simulation model to perform the time-step iteration.

17. The medium according to claim 15, wherein performing a time-step iteration on the basis of a wave-field numerical simulation model and adopting a spatial filtering method to filter out unstable wave-field components distributed in the high wave number region comprises:
performing the time-step iteration on the basis of the wave-field numerical simulation model to figure out a maximum wave number threshold corresponding to the given time step and meeting a CFL stability condition;
when the time-step iteration ends, transforming a spatial domain to a wave number domain;
filtering out wave-field components greater than the maximum wave number threshold by a low-pass filter; and
after filtering, transforming the wave number domain back to the spatial domain, and performing a next time-step iteration.

18. The medium according to claim 17, wherein parameters of the wave-field numerical simulation model include a spatial grid size, a maximum speed of the model, a time step, and a discretization scheme of time and spatial variables, the CFL stability condition corresponding to the maximum wave number threshold is a critical state of the CFL stability condition, the spatial domain is transformed to the wave number domain by means of Fourier transform, and the wave number domain is transformed to the spatial domain by means of inverse Fourier transform.

19. The medium according to claim 17, wherein an expression of the low-pass filter is:
$$F ( k ) = \{ \begin{matrix}1 , & k \leq K max \\ 0 , & Others ,\end{matrix}$$
wherein, F(k) is the low-pass filter, k is a wave number, and an upper limit of the low-pass filter is the maximum wave number threshold Kmax.

20. The medium according to claim 15, wherein the inverse time-dispersion transform comprises the following steps:
calculating an actual phase shift θ(ω, Δt) regarding an effective frequency according to a dispersion relation obtained after time discretization, wherein ω is a frequency, and Δt is a time step;
applying a transformation: û′(ω)=∫u(t)e^{-i[θ(ω, Δt)/Δt]t}dt, wherein u(t) is the target wave-field data required to be output; and
performing inverse Fourier transform:
$${u}^{′} ( t ) = \frac{1}{2 π} \int {{u}^{\text{?}}}^{′} ( ω ) {e}^{i \text{?}} d ω$$
$$\text{?} \text{indicates text missing or illegible when filed}$$
to obtain the wave-field data u′(t) with time dispersion removed.
